(19) United States
(12) Patent Application Publication
(10) Pub. No.: US 2018/0130316 A1
(43) Pub. Date: May 10, 2018

(54) Event Tracker System And Method

(71) Applicant: Lauren Longo, Roswell, GA (US)

(72) Inventor: Lauren Longo, Roswell, GA (US)

(21) Appl. No.: 15/787,350

(22) Filed: Oct. 18, 2017

Related U.S. Application Data
(63) Continuation-in-part of application No. 15/635,180, filed on Jun. 27, 2017.
(60) Provisional application No. 62/409,869, filed on Oct. 18, 2016.

(51) Int. Cl. G08B 5/22; G06F 3/0484

(52) U.S. Cl. CPC G08B 5/226; G06F 3/04842

(57) ABSTRACT

An event tracker system for transmitting and recording events, the event tracker system including an event tracker and software application. The event tracker is an energy source powered-device with an electronically coupled plurality of buttons for activating the device and transmitting event data, and a time and date stamp associated with the specific chosen plurality of buttons as indicated by event specific iconic symbols. The event tracker has a housing with a flat mounting method, a user interface electronically coupled to an electronics board for activating the device and transmitting the event data via a wireless communications link. The software application is configured and uniquely keyed to communicate securely and solely with the event tracker and receives the event data via the wireless communications link. The software application has various application screens for presenting recorded data to a user.

### CROSS-REFERENCE TO RELATED APPLICATION(S)

The present application is a continuation-in-part of co-pending U.S. patent application Ser. No. 15/635,180, filed Jun. 27, 2017, with benefit of U.S. Provisional Patent Application No. 62/409,869 filed Oct. 18, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of event tracking, and more specifically relates to a wireless event tracker.

### RELATED ART

The tracking of frequently occurring events is useful in a variety of applications, such as when caring for an infant, child, elder, or pet. When caring for an infant, parents or caretakers may lose track of how many times per day and night the infant has been fed and changed. They may also not have an accurate record of the baby's sleeping schedule. This information is vital for responding to pediatrician questions and scheduling activities. Many times parents and caretakers do not have a proper way for recording this data and may often be without a smartphone or pen and paper, especially at odd hours of the night. It can be difficult to identify trends and patterns of behavior without an accurate method of recording data or a simplified method of recording data. Recording accurate data is especially challenging during dimly lit conditions while barely awake which often occurs while parenting or for hired help with limited computer skills or reading ability.

U.S. Pub. No. 2014/0198623 to Hill relates to a Multi-Event Time and Data Tracking Device. The described disclosure includes the battery operated baby care tracking device comprising an information screen on the face of the device, displaying the date and time in one mode and recent baby care information in corresponding modes; a first group of buttons on the same face of the device, including clear and decimal point buttons; a second group of buttons labeled as baby feeding events, including nursing, pumping and bottle and baby food feeding, including buttons to indicate the left and right breast; a third group of buttons labeled as baby care information, including diapers, sleeping, crying, medicine, vomiting, temperature and a generic baby care event which are used for data entry and review; a fourth group of buttons having two scan buttons allowing the reviewer to scroll through data; an Alarm switch, on a first or second side of the device, by which the caregiver can set an audible and/or vibration and/or backlight alarm for a particular time or time increments; a Lock switch, on the first or second side of the device, which locks the device or allows input and review of information in different positions; a Light switch on the side of the device, which can be switched Off, On or to the Nighttime position; a microprocessor for providing temporary memory storage for the device and mode selection for each of the buttons and a USB port on a side of the device as well as wireless communication capability for data transfer from the device to a permanent memory storage in the mobile device via the mobile application software.

The disadvantage of the cited prior art is that the device is too complicated. It requires too much time and effort to record even simple events, and it comes with a learning curve to use it at all. Sleep-deprived parents need a simple, one-touch mechanism for tracking infant care events. Finding the correct button out of so many buttons on the face of this device will be challenging and error-prone. Parents don't always have the bandwidth to navigate a complex user interface or enter data while holding/caring for an infant. This becomes especially true during late-night feedings, diaper changes, etc. Additionally, this device in the prior art is storing data on the device itself. This requires additional storage/computing capacity in the device, as well as added complexity of design to allow for screen display and navigation. Storing data on the device itself requires the user to extract the data to a computer or other device to analyze the data and generate shareable reports. Parent, caregivers, and doctors need real-time data they can view and analyze without the step of having to download, transfer, or otherwise extract the full data set from the event tracking device to a computing device.

Accordingly, there is a need in the art for an improved event tracking system. It is to such that the present invention is directed.

### SUMMARY OF THE INVENTION

In view of the foregoing disadvantages inherent in the known wireless event tracker art, the present disclosure provides a novel event tracker system and method. The general purpose of the present disclosure, which will be described subsequently in greater detail, is to provide a one-touch, wireless event tracker system and method that transmits data in real time to a datastore for access by a mobile device configured with a software application for analysis and reporting of tracked events.

An event tracker system is disclosed herein. The event tracker system including an event tracker and a mobile device configured to communicate with the event tracker. The event tracker includes a housing including a means for mounting to a flat surface, an electronics board embedded in the housing having a controller including an embedded processor and configured to communicate over a wireless communication link, a user interface coupled to the housing, the user interface including a plurality of buttons for activation, data event recording, and transmission upon a single, multiple, or long pressing, each button being backlit and having unique icon images. The controller is communicably coupled to the wireless communication radio and the user interface. The controller is configured to associate an input from each of the plurality of buttons with a time, a date, and at least one of a unique event and class of event as an event message. The controller is further configured to communicate the event message over the wireless communication link via the wireless communication radio to a software application on the mobile device. The event tracker further includes an indication light coupled to the housing and configured to indicate at least one of an “ON”, wireless communication link, or a charge status. The event tracker further includes an energy storage coupled to the housing and configured to power the event tracker, and a power port and the electronics board coupled to the housing, electronically coupled to the energy storage, and configured to provide external power to the event tracker. The mobile device is configured to communicate with the event tracker over the wireless communication link, and to execute a mobile application on the mobile device, the mobile application configured and uniquely keyed to communicate securely and solely with the event tracker, the mobile application configured to display a plurality of information screens.

According to another embodiment, a method of use for the event tracker is also disclosed herein. The method of use for the event tracker includes the steps of providing an event tracker system, charging the event tracker, and pressing any of the plurality of buttons to activate the event tracker and transmit the associated event. The method of use for the event tracker further includes the steps of recharging the event tracker.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an event tracker system, constructed and operative according to the teachings of the present disclosure.

FIG. 1 is a view of the event tracker system during an ‘in-use’ condition, according to an embodiment of the disclosure.

FIG. 2 is a perspective view of the event tracker system of FIG. 1, according to an embodiment of the present disclosure.

FIG. 3 is a schematic diagram of the event tracker of FIG. 1, according to an embodiment of the present disclosure.

FIG. 4A is a plan view of a display of a mobile device interacting with the event tracker of FIG. 1, according to an embodiment of the present disclosure.

FIG. 4B is a plan view of the display of the mobile device interacting with the event tracker of FIG. 1, according to an embodiment of the present disclosure.

FIG. 4C is a plan view of the display of the mobile device FIG. 4A interacting with the event tracker of FIG. 1, according to an embodiment of the present disclosure.

FIG. 5 is a flow diagram illustrating a method of use for an event tracker system, according to an embodiment of the present disclosure.

FIG. 6 illustrates a representative event entry screen in the application configured for use on a mobile communications device.

FIG. 7 illustrates an electronic application embodiment of the present invention configured on a mobile communications device.

FIG. 8 illustrate a customization feature of the electronic application embodiment illustrated in FIG. 7.

FIG. 9 illustrates a button customization page for selectively providing a button label, an icon, and attributes associated with the button.

FIG. 10A illustrates an alternate embodiment of the event tracker device for selective customization of events for tracking.

FIG. 10B illustrates a second alternate embodiment of the event tracker device for selective customization of events for tracking.

FIG. 11 illustrates an images selection display screen for selecting an icon for association with an event for facilitating tracking with the present invention.

The various embodiments of the present invention will hereinafter be described in conjunction with the appended drawings, wherein like designations denote like elements.

### DETAILED DESCRIPTION

As discussed above, embodiments of the present disclosure relate to a detecting, measuring or recording for diagnostic purposes; identification of persons and more particularly to an event tracker system as used to improve using wireless means.

Generally speaking, many people like to track activities so that they can plan their day accordingly and/or provide data for reporting to doctors, veterinarians, caretakers, etc. An event tracker system is a device or application for monitoring and tracking specific functions performed throughout the clay and night. The event tracker activates and transmits data with a single button press, multiple button press, or long press for immediate recording on a mobile device or mobile communications device having a mobile application software. The event tracker has a plurality of buttons, with common or universal symbol icon images relating to a specific event, that enable ease of use especially for those with limited computer and language skills. The buttons may be configurable in regards to what they are tracking. The event tracker system may be used for activities performed singly or recurrently. The present disclosure provides a battery-powered, wireless-enabled device, designed to transmit a specific activity/event as well as a date and time stamp as an immediate transmission.

According to one embodiment, the wireless-enabled device may be configured to transmit the specific activity/event as well as a date and time stamp as an immediate transmission without resident memory storage (e.g., a datalogger) on the event tracker. The transmitted data may be stored in the cloud or in the mobile device via the immediate application of the application software. Advantageously, this may offer caretakers of infants, children, stable animals, elders, or pets an easy and efficient method for tracking and recording multiple occurrences of recurring events, such as feedings, diaper changings, and the like while keeping the event tracker simple without the complexity of storing data.

According to one embodiment, the device may include a flat surface mounting or means for mounting the device to a flat surface, this mounting technique or method may allow users to attach the unit to any hard surface in a home, daycare center, animal boarding facility, or other location where the tracking of events is needed. The event tracker pairs with the software application which can be accessed via mobile device or computer, where users can login to view reports based on the data submitted from the device. Aspects of the present disclosure may offer trend analysis and reports for all events tracked with the mobile application software.

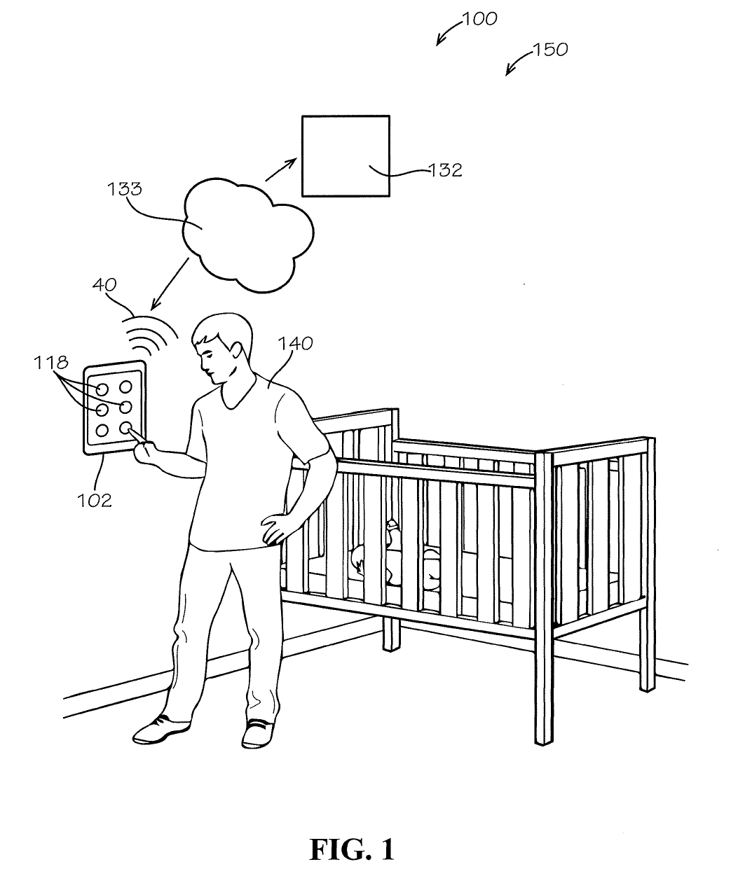

Referring now more specifically to the drawings by numerals of reference, there is shown in FIGS. 1-4, various views of an event tracker system 100.

FIG. 1 shows an event tracker system 100 during an ‘in-use’ condition 150, according to an embodiment of the present disclosure. In a preferred embodiment, a tracking device 102 may be mounted on a wall beside a crib 10 and the parent/caregiver may press one of a plurality of buttons 118 on the device, or selectively, displayed on a mobile device 130 configured with an electronic software application for event tracking, to record an event. The mobile device 130 is a mobile communications device such as a smart phone, tablet, or microprocessor device, for example, an IPHONE phone or an IPAD tablet device.

The event tracker 102 may be beneficial for use by a user 140 standing adjacent to a crib 10 to record an event. Alternatively, the user may gainfully use the mobile device 130 that executes software instructions in a mobile application. The mobile device 130 communicates the selected event button and the date and time information over a wireless communication link 40 to the datastore 132. For example, the recorded event may be a diaper change, a feeding, or a sleep state along with a time and date stamp. The event tracker 102 may include a user interface 116 configured allow the user 140 to interact with the mobile device 130.

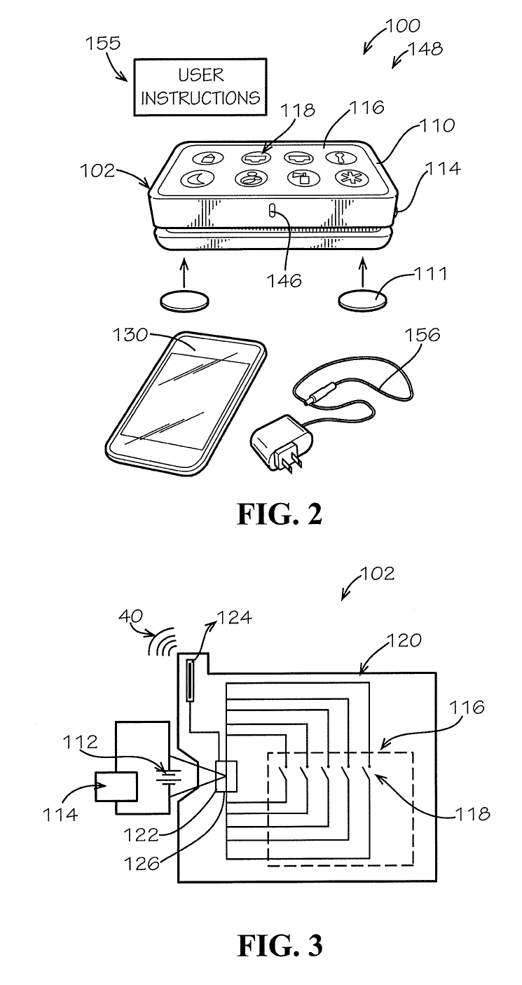

FIG. 2 is a perspective view of the event tracker system of FIG. 1, according to an embodiment of the present disclosure. As above, the event tracker 102 may include the user interface 116. The user interface 116 may have plurality of buttons 118 configured for data entry. The buttons 118 may be backlit to facilitate use at night or in darkened rooms. The event tracker 102 may further include a housing 110, where the user interface 116 is coupled to the housing 110. The housing 110 may include a mount (e.g., a retention clip, a flat surface mount 111, etc.). Here, the mount of the housing 110 embodied as the flat surface mount 111. Further, the mount of the housing 110 may be configured to connect the event tracker 102 to an object, such as the crib 10 (FIG. 1), a refrigerator, a kennel, or a stable. In an alternate embodiment, the user interface 116 comprises an interactive LED screen configured to display the plurality of buttons 118 each configured with a respective symbol or graphic that indicates the respective specific event and configured to perform the same functions as the mechanical buttons.

The event tracker 102 may include an LED light 146 configured to indicate an “ON” wireless communication connection, or a charge status. The event tracker 102 may further include a power port 114 configured to electrically couple the event tracker 102 to an external power supply (battery charger 156) configured to charge the event tracker 102.

Pressing one of the plurality of buttons 118 immediately activates the event tracker 102 and sends associated event data to the datastore 132 (FIG. 1) though a telecommunications network 133. The datastore 132 is a remote database memory storage device for receiving and maintaining event data, which remote device is accessed by the application on the mobile device 130 for generating event reports as discussed below. The datastore 132 may be housed on an independent remote microprocessor-based electronic memory device. Alternate embodiments of the event tracker 102 has a “time out” sleep feature after a period of nonuse, a status indication where the LED indicator light 146 is constantly lit while in an “ON” state, a status indication where the LED indicator light 146 emits a single pulse, timed flash when fully charged, and a status indication where the LED indicator light 146 emits a triple pulse, timed flash when the wireless communication link 40 is lost. A single short press of any button 118 submits event ID, date, and time of that button press. An initial short press to send date and time may be subsequently followed with multiple subsequent presses of that same button 118 within an established threshold of time to submit amount/volume increments to equal a total amount/volume (duration) associated with the event. The amount/volume unit of measure and increments would be configured in the software application. A long press clears/resets the wireless connection credentials saved to the device.

The event tracker system 100 may be configured as a kit 148 including a battery charger 156, and a set of instructions 155. The instructions 155 may detail functional relationships in relation to the structure of the event tracker 102 such that the event tracker system 100 can be used, maintained, or the like, in a preferred manner.

FIG. 3 is a schematic diagram of the event tracker 102 of FIG. 1, according to an embodiment of the present disclosure. The event tracker 102 may include electronics or modules configured to enable its functionality, which may be, for example, mounted to and/or communicably coupled to an electronics board 120 internally mounted to the housing 110 (FIG. 2). As shown, the event tracker 102 may include a wireless communication radio 124, the user interface 116 having the plurality of buttons 118 (modeled here as a plurality of switches), controller 126, an energy storage 112, and power port 114. The energy storage 112 may be electronically coupled to the plurality of buttons 118, the controller 126, and the power port 114. In a preferred embodiment the energy storage 112 is a battery that is recharged by the battery charger 156 (FIG. 2), although in an alternate embodiment energy storage 112 comprises an AC power source or a solar array.

The wireless communication radio 124 communicates event data 40 to the datastore 132 via a telecommunications network. Subsequently, the mobile device 130 (FIG. 1) via the mobile application operating on the mobile device 130 accesses the datastore 132 for analysis and reporting on tracked events. Data transmission may be initiated by pressing any of the plurality of buttons 118 which are configured to activate the event tracker 102 and immediately send the event information to the datastore 132 for access in real time by the application operating on the mobile device 130.

The controller 126 may include an embedded processor 122. The controller 126 may be configured to communicate the event data over the wireless communication link 40 via the wireless communication radio 124.

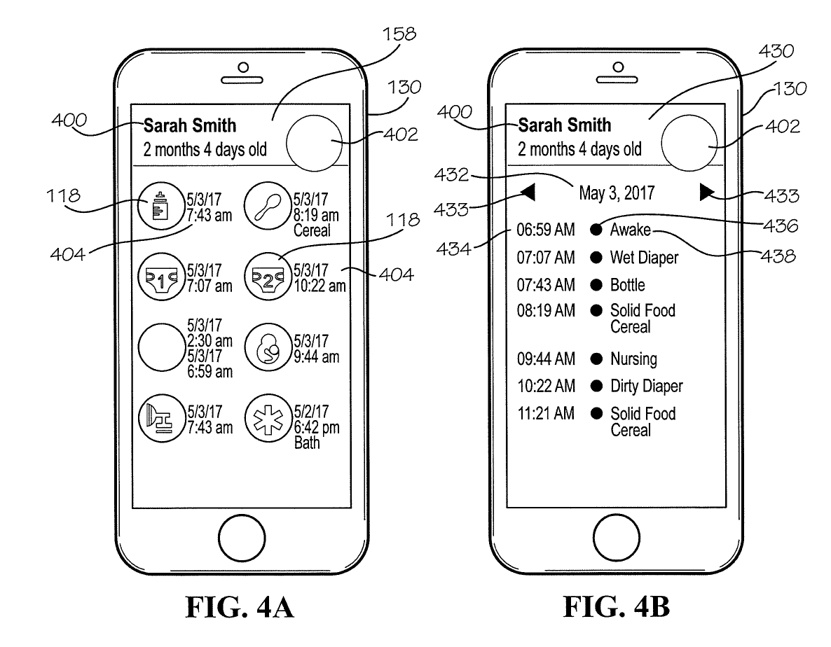

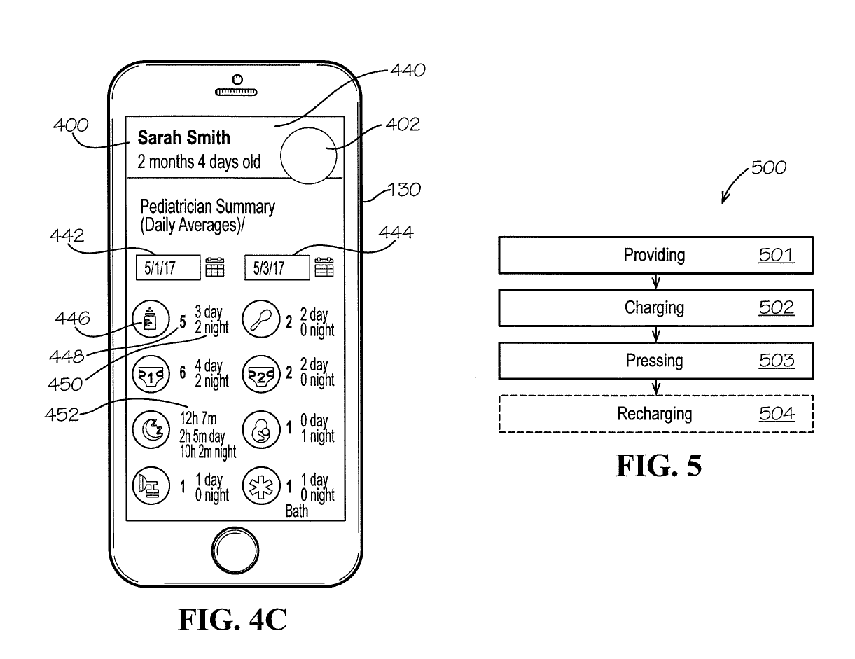

According to one embodiment, the user interface 116 and the controller 126 having an embedded processor 122 are configured to associate an input from each of the plurality of buttons 118. Activation of the event tracker 102 is initiated by pressing one of the plurality of buttons 118. Each subsequent pressing of the plurality of buttons 118 results in the activation of the event tracker 102 and the transmission of an event associated with the iconic symbol on the plurality of buttons 118 along with a time and date stamp. The transmitted data includes a time, a date, and at least one of a unique event and class of event as an event message, the events for the preferred embodiment including diaper changes, feedings, wake time, sleep time, and a user-configurable miscellaneous events, each associated with an icon symbol displayed on a respective one of the plurality of buttons 118. Events for alternate embodiments may include stable cleaning, watering, and feeding of livestock in a stable with associated iconic symbols for the plurality of buttons 118 and the phone application software screens 158 (FIGS. 4A-C).

FIGS. 4A, 4B, and 4C are plan views of various exemplary phone application software screens 158 that are configured to work together in functional combination with the event tracker 102 of FIG. 1 according to an embodiment of the present disclosure. Phone application software screens 158 are shown to duplicate the event tracker 102 plurality of buttons 118 (FIG. 4A), provide a summary report of the events with a date and time stamp (FIG. 4B), and show an average of the daily data gathered (FIG. 4C). FIGS. 4A, 4B, and 4C are illustrative embodiments, representing a sample of the phone application software screens 158 which may be expanded upon for various events associated with infant care. FIGS. 4A, 4B, and 4C may represent other events such as elder care, stable or kennel maintenance, or other events for tracking purposes in alternate embodiments.

The application on the mobile device 130 includes a features menu page 470, as shown in FIG. 7. The menu page 470 includes buttons for accessing available features of the tracking and reporting system, including a home page 471, daily list 472, pediatrician summary 474, detail report 476, settings 478, customize 480 and sign out 482. The home page 471 button accesses the report illustrated in FIG. 4A. In an alternate embodiment, the report is active in that a respective one of the displayed buttons 118 may be selected for entry of the associated event by using the mobile device 130. In this embodiment, the application communicates the event information (event type, date, and time, for example), to the datastore 132. The button for the daily list 472 accesses the report illustrated in FIG. 4B. The button for the pediatrician summary 474 accesses the report illustrated in FIG. 4C. The button for the detail report 476 accesses a detailed report (not illustrated). The detailed report similar to the pediatrician report shown in FIG. 4C, includes user-selectable date range and selected one or more of the tracked events which are of interest. The application generates a visual representation of event occurrence dates and times across the time range. The detailed report provides for observing trends and identifying exception occurrences. The reports illustrated in FIGS. 4A-4C are discussed below. The button for the system settings 478 provides conventional user identification data fields (not illustrated), for example but not limitation, user name and password. The button for customization 480 presents display screens for user selection of event icon, label, and additional attribute, as discussed below.

FIG. 4A illustrates on the screen 158 a personalization feature with a name field 400 and an image field 402. The name field 400 contains a name of the person associated with the tracked information and the image field 402 displays an image such as a photo or graphic associated with the person. A data entry screen (not illustrated) enables conventional entry and editing of alphanumeric information for the name field 400 (such as using a display screen keyboard). The image field 402 may be provided with an image using a camera on the mobile communications device (for example, configured for activation of the camera and entry of the image or selection through a browse window to locate an image data file) The buttons 118 duplicate the buttons on the event tracker 102. In the illustrated embodiment, a data field generally 404 displays the date, time, and notes associated with the last entry for a respective button 118.

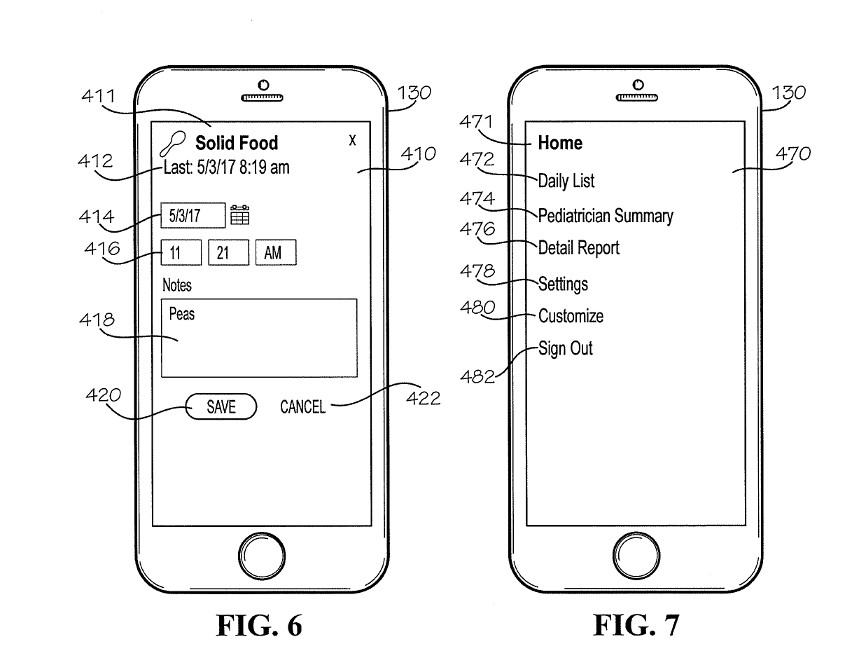

FIG. 6 illustrates a representative event entry screen 410 activated upon selection of a respective button 118. The event entry screen illustrated in FIG. 6 is for a “solid food” button. The screen 410 includes an event title or name field 411 and the associated icon. A “last entered” field 412 displays date and time of the prior entry associated with the event button. A calendar field 414 and time field 416 displays the date and time on which the button 118 was pressed for entry of an event. A notes field 418 enables text entry for notes associated with the event. A save button 420 causes the application to upload the event, date, time and notes to the database. A cancel button 422 cancels the action of event entry and returns the application to the home display screen.

FIG. 4B illustrates a summary report 430 of recorded daily events. The summary report 430 includes the name field and the image field 402. A date field 432 shows the date of the displayed daily events. Scroll arrows 433 enable selective movement forward and backward relative to the date to show information for other selected dates. The report 430 includes a time field 434, a status symbol 436 such as a color displayed to indicate event type, and an event label 438 containing a text description of the event and associated notes if any. A user may scroll through the listed events, and select an event to view/edit the details of that event.

The application is configured for providing an aggregating report 440 as shown in FIG. 4C. The report 440 averages the occurrences and associated attributes of each event type during a user-specified time period. The report 440 includes start date 442 and end date 444. The report 440 displays the event icon 446 and the relevant event information, i.e., the average number of event occurrences 448, event day or night 450, or duration 452.

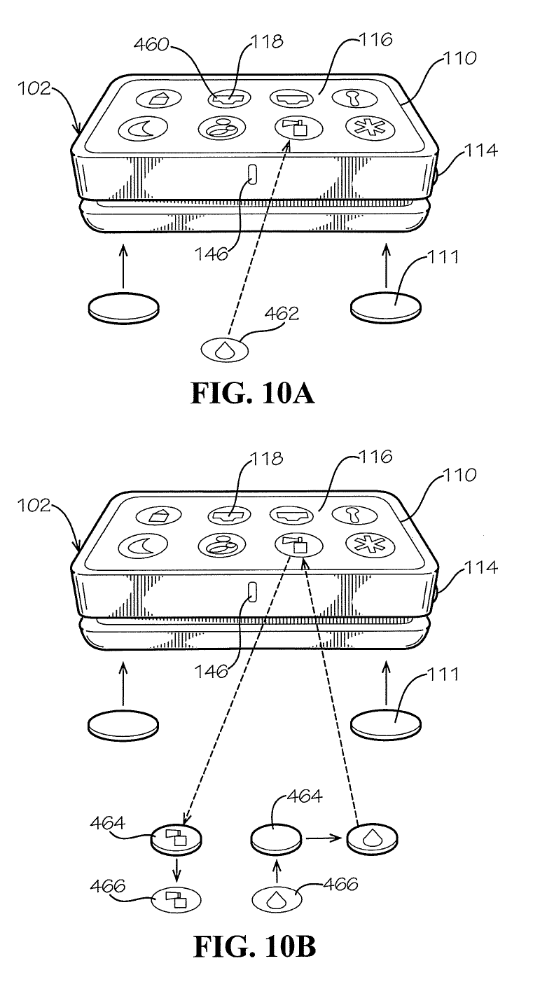

The apparatus in accordance with the present invention may be customized by changing the events tracked by a respective button 118 on the device 100 and the application installed on the mobile device 130. The system thus can readily be reconfigured to track additional events other than the preconfigured events originally provided with the device and application. For example, a system may be preconfigured with infant care activities. After a first period, for example, a first year, the user may no longer need tracking of infant feedings, diapers, and sleep. The icons are readily changed to track altogether different events for example, toilet training, daily chores, pet animal care, medication, or other event. In a first embodiment shown in FIG. 10A, each button 118 includes an icon sticker 460. The graphic shown on the icon sticker 460 is representative of the particular event to be tracked. A new sticker 462 having an icon representative of the new event is selected from a supply of sticker icons (not illustrated). The sticker 462 has an adhesive backing which adheres the new sticker to the selected button. Alternatively, as illustrated in FIG. 10B, the button 118 includes a detachable cap 464. An icon insert 466 seats in the detachable cap. The icon insert for the prior tracking event is removed and the icon insert for the new tracking event inserted. The cap 464 is then replaced on the button 118. The icon insert 466 may be selected from a plurality of graphic icon provided on a sheet or downloaded from a source file for printing.

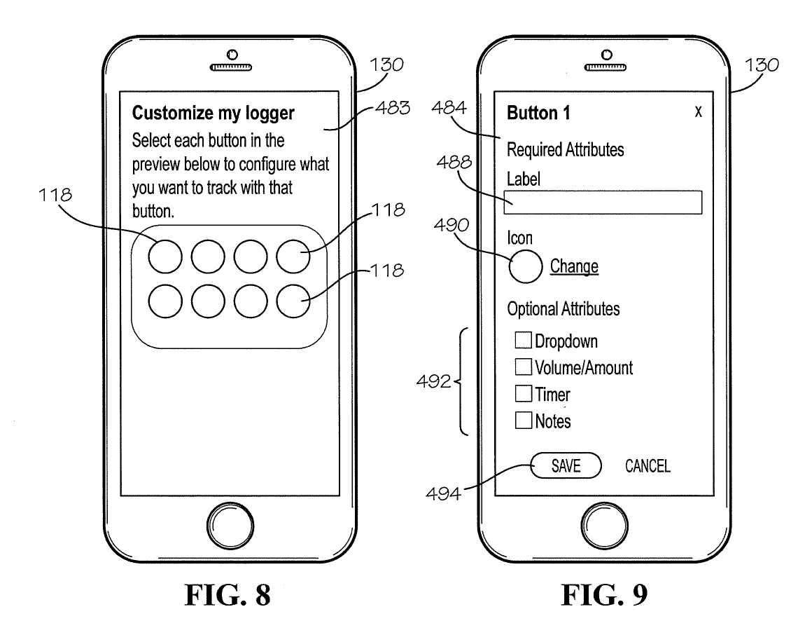

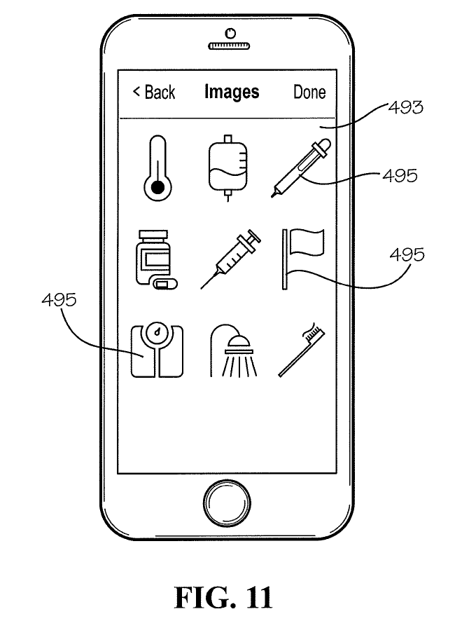

The user may selectively customize the buttons 118 as to event icon, label, and additional attributes on the mobile device 130. The customization feature is accessed through the button 480 which displays a matrix of the buttons 118 for selection. FIG. 8 illustrates a page 483 that displays the activities or events currently available through the respective icon button 118. The user selects one of the icon buttons 118 to edit or customize. Upon selecting one of the icons, the application presents a button customization screen 484 as shown in FIG. 9. The screen 484 may designate the location of the selected button 118 such as by highlighting in a buttons matrix. The attributes of the button are selectable, including a button label field 488, a button icon selector 490, and optional attributes 492. The button label field 488 enables entry of alphanumeric characters with a conventional display keyboard presented on the display screen of the mobile communications device 130. The change icon button 490 opens a conventional browser window function on the mobile device 130. The user navigates in the browser window to select the graphic data file of the icon that is to appear in the application displays for the selected button. Alternatively, the device opens an images file as shown in FIG. 11 for display 493 and selection of a graphic or icon 495 from a plurality of available icons to associate with the selected event button 118. The user may scroll though the available icons. The icons may be, for example, international standard symbols associated with child care, animal care, elder care, kennel or stable maintenance, or other event activities for which tracking is desired. With continuing reference to FIG. 9, the additional attributes 492 includes check boxes for features to associate with the selected button. These include dropdown menu, volume or amount criteria, timer, and notes. A save button 494 causes the application to save the changed label, icon, and attributes for the selected button 118.

FIG. 5 is a flow diagram illustrating a method of use 500 for an event tracker system 100, according to an embodiment of the present disclosure. In particular, the method use 500 may include one or more components or features of the event tracker system 100 as described above. As illustrated, the method of use 500 may include the steps of: step one 501, providing the event tracker system 100; step two 502, charging the event tracker system 100; and step three 503, pressing one of the plurality of buttons 118 on the event tracker 102 to activate event tracker 102 and send associated event data to the mobile device 130. The method of use 500 may further include the step of step four 504, recharging the event tracker system 100.

It should be noted that the steps described in the method of use can be carried out in many different orders according to user preference. The use of “step or should not be interpreted as “step for”, in the claims herein and is not intended to invoke the provisions of 35 U.S.C. § 112. It should also be noted that, under appropriate circumstances, considering such issues as design preference, user preferences, marketing preferences, cost, structural requirements, available materials, technological advances, etc., other methods for transmitting and recording event data are taught herein.

The event tracking system is operated by positioning the device 102 in a suitable location proximate activities subject to tracking, for example in FIG. 1 mounted to a wall of a baby's room for tracking child care events. The electronic application installs on the mobile device 130. Upon occurrence of an event for tracking, the appropriate button 118 indicated by the icon displayed thereon is selected. The event type, date, and time communicates 40 to the datastore 132 via the application operating on the mobile device. The wireless radio 124 communicates with the mobile device 130 which in turn communicates with the remote datastore 132. An alternate embodiment provides access to tracking events through a voice-response network command and information retrieval device. Such devices may be alternatively supplied by third party services providers, such as an ECHO for ALEXA voice command device for network assess. Voice commands enable logging events. The voice command includes the event label and uploads to the datastore the event time, the day date and time.

With reference to FIG. 7, event reports are selectively displayed using the buttons 472 for the daily list report that includes the event tracker page with selectable buttons 118 and daily events shown in FIG. 4A, the summary report 474 for events occurring on a selected day as shown in FIG. 4B, and an averages report as shown in FIG. 4C. Further, the settings page 48 presents screens for configuring the application (such as user name, login and password (not illustrated) and like user selected information and settings.

The customize button 480 enables the user to customize the events buttons for tracking. Upon selection, the application presents (see FIG. 8), the buttons matrix for selecting the button 118 to customize. The customization screen shown in FIG. 9 enables entry 488 of a button label, selection 490 of an icon, and selection 492 of optional attributes. Upon customization, the information is saved 494.

As noted above, the buttons 118 may be selectively changed on both the device 102 and the application on the mobile device. In reference to FIG. 10A the icon displayed on the button 118 may be selectively changed with positioning of a sticker 462 containing a new icon representing the event to be tracked by operation of the selected button. In reference to FIG. 10B, a selected button is changed by detaching the cap 464 and positioning a new icon insert 466. The cap 464 is then replaced on the respective button. The buttons 118 on the mobile device 130 are changed by using the customize button 480 for selecting which button 118 to change (see FIG. 8) and using the screen 484 (see FIG. 9) to selectively change the label 488, the icon 490, and the attributes 492 associated with the selected button. The present invention accordingly provides a convenient and readily usable user-specified event tracking system.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An event tracker system comprising:
an event tracker including
a housing including means for mounting to a flat surface;
a wireless communication radio embedded in the housing and configured to communicate over a wireless communication link;
a user interface coupled to the housing, the user interface including a plurality of buttons for activation, data event recording, and transmission upon a single, multiple, and alternatively long pressing, each button being backlit and having unique icon images;
an electronics board embedded in the housing having a controller including an embedded processor, the controller communicably coupled to the wireless communication radio and the user interface, the controller configured to associate an input from each of the electronically coupled plurality of buttons with a time, a date, and at least one of a unique event and class of event as an event message, the controller further configured to communicate the event message over the wireless communication link via the wireless communication radio to a software application on a handheld mobile device;
an indication light mechanically coupled to the housing, electronically coupled to the electronics board and configured to indicate at least one of an “ON”, wireless communication link, or a charge status;
an energy storage mechanically coupled to the housing, electronically coupled to the electronics board and configured to power the event tracker;
a power port coupled to the housing, electronically coupled to the energy storage, and configured to provide external power to the event tracker; and
a software application accessed via mobile device or computer, the application configured and uniquely keyed to communicate securely and solely with the event tracker, the mobile application configured to display a plurality of information screens.

2. The event tracker of claim 1, wherein the plurality of buttons include icon images representing infant activities including at least one of a diaper change, infant feedings of various types, an infant waking, and infant sleep times, and further representing an undefined or “miscellaneous” event.

3. The event tracker of claim 1, wherein the energy storage is a battery.

4. The event tracker of claim 1, wherein the controller further includes a clock configured to provide the event message with the time the date, the clock being modifiable by a user.

5. The event tracker of claim 4, wherein the event message includes a real-time time and date stamp automatically included by the clock.

6. The event tracker of claim 1, wherein the event tracker is configured to be activated by operation of any of the plurality of buttons.

7. The event tracker of claim 1, wherein the event tracker is configured to enter a sleep state after passage of a predefined amount of time without operation of any of the plurality of buttons.

8. The event tracker of claim 1, wherein the indication light is configured to remain lit while when an event for that button press is being transmitted.

9. The event tracker of claim 1, wherein a single LED on a side of the device will be used only to indicate low battery charge and/or full recharge status,

10. The event tracker of claim 1, wherein the application software is configured to record and organize transmitted event data into various reports.

11. The event tracker of claim 10, wherein the phone application software contains a screen that mimics the plurality of buttons with icon images.

12. The event tracker of claim 1, wherein the plurality of buttons have updatable, printed icon images configured with symbols that indicate specific events.

13. The event tracker of claim 1 wherein the energy source is charged by a battery charger, AC power source, or solar array.

14. The event tracker of claim 1, wherein the icon images on the user interface includes an interactive LED screen configured to display the plurality of buttons configured with symbols that indicate specific events and configured to perform the same functions as the plurality of backlit buttons.

15. The event tracker of claim 1 wherein the unique icon images of the plurality of buttons include international symbols associated with animal care, elder care, kennel or stable maintenance.

16. The event tracker of claim 1, wherein the buttons are selectively customizable for reconfiguring to a different event for tracking.

17. The event tracker of claim 16, wherein the icon comprises a sticker selectively attached for depicting the event for tracking.

18. The event tracker of claim 16, wherein the button comprises a detachable cap that holds an insert displaying the icon, whereby a respective button is changed to a new event type for tracking by replacing the insert received in the detachable cap.

19. The event tracker of claim 16, wherein the application is configured for selectively configuring a respective button with a button label.

20. An event tracker system comprising:
an event tracker including
a housing including a means for mounting to a flat surface;
a wireless communication radio embedded in the housing and configured to communicate over a wireless communication link;
a user interface coupled to the housing, the user interface including a plurality of buttons for activation, data event recording, and transmission upon a single pressing, multiple pressing, or long pressing, each button being backlit and having unique icon images;
an electronics board embedded in the housing having a controller including an embedded processor, the controller communicably coupled to the wireless communication radio and the user interface an electronics board embedded in the housing having a controller including an embedded processor, the controller communicably coupled to the wireless communication radio and the user interface, the controller configured to associate an input from each of the electronically coupled plurality of buttons with a time, a date, and at least one of a unique event and class of event as an event message, the controller further configured to communicate the event message over the wireless communication link via the wireless communication radio to a software application on a handheld mobile device;
an indication light mechanically coupled to the housing, electronically coupled to the electronics board and configured to indicate at least one of an “ON”, Wireless communication link, or a charge status;
an energy storage mechanically coupled to the housing, electronically coupled to the electronics board and configured to power the event tracker;
a power port coupled to the housing, electronically coupled to the energy storage, and configured to provide external power to the event tracker; and
a mobile device configured to communicate with the event tracker over the wireless communication link, and to execute a mobile application on the mobile device, the mobile application configured and uniquely keyed to communicate securely and solely with the event tracker, the mobile application configured to display a plurality of information screens; and
wherein the plurality of buttons include icon images representing infant activities including at least one of a diaper change, an infant feeding, an infant waking, and infant sleep times, and further representing an undefined or “miscellaneous” event;
wherein the energy storage is a battery;
wherein the controller further includes a clock configured to provide the event message with the time the date, the clock being modifiable by a user;
wherein the event message includes a real-time time and date stamp automatically included by the clock;
wherein the event tracker is configured to be activated by operation of any of the plurality of buttons;
wherein the event tracker is configured to enter a sleep state after passage of a predefined amount of time without operation of any of the plurality of buttons;
wherein the indication light is configured to remain lit while in an “ON” state; wherein the indication light is configured to emit a single pulse, timed flash when the energy storage fully charged;
wherein the indication light is configured to emit a triple pulse, timed flash when the wireless communication link to the software application is not connected;
wherein the phone application software is configured to record and organize transmitted event data into various reports;
wherein the phone application software contains a screen that mimics the plurality of buttons with icon images; and
wherein the energy source is charged by a battery charger, AC power source, or solar array.

21. The event tracker system of claim 20, further comprising:
set of instructions; and
a battery charger; and
wherein the event tracker system is arranged as a kit.

22. A method of use for an event tracker, the method comprising the steps of:
providing an event tracker system;
charging the event tracker; and
pressing any of a plurality of buttons to activate the event tracker and transmit an associated event.

23. A method of use for an event tracker of claim 22, the method further comprising the step of recharging the event tracker.
